(19) United States
(12) Patent Application Publication
(10) Pub. No.: US 2011/0162899 A1
(43) Pub. Date: Jul. 7, 2011

(54) ELECTRIC ENGINE ARRANGEMENT

(76) Inventor: Ross Blade, Victoria (AU)

(21) Appl. No.: 13/060,728

(22) PCT Filed: Aug. 25, 2009
(86) PCT No.: PCT/AU2009/001094

§ 371 Date: Mar. 21, 2011

(30) Foreign Application Priority Data
Aug. 25, 2008 (AU) 2008904548
Oct. 24, 2008 (AU) 2008905499

(51) Int. Cl. B60K 1/00; B23P 23/00

(52) U.S. Cl. 180/65.1; 29/401.1

(57) ABSTRACT

An electric vehicle engine arrangement (10) for a retro-fitting to a vehicle which has engine mounts suitable for mounting an internal combustion engine. The arrangement (10) includes a mounting member (11) for mounting an electric motor (12) in the engine bay of the vehicle. The mounting member (11) is anchored to the existing engine mounts of the vehicle and the electric motor (12) is mounted to the mounting member (11).

### FIELD OF THE INVENTION

This invention relates to an electric engine arrangement in which an electric engine is mounted within the engine bay of a vehicle and the invention extends to components associated with the mounting arrangement and methods employed in installation of the arrangement.

The invention has been developed principally for the retro-fitting of an electric traction motor to a vehicle which was formally driven by an internal combustion engine although it will be appreciated that the invention has application to the new vehicle market, so that it is not restricted to retro-fitting applications.

It will however be convenient to describe the invention in relation to its use in a retro-fitting environment, although the reader will appreciate that the invention is not restricted to that environment as in indicated above.

### BACKGROUND OF THE INVENTION

Retro-fitting of electric motors to vehicles which have originally been built to include an internal combustion engine, takes place already. However, the applicant is aware that some existing arrangements for retro-fitting can reduce the ability of vehicles, particularly front wheel drive vehicles, to absorb frontal impact loads during vehicle collisions, when compared to the original vehicle fitted with an internal combustion engine. Such a reduction in frontal impact absorption reduces the attractiveness of an electric motor retro-fit, despite the environmental advantages retro-fit of an electric motor can provide.

Applicant is also aware that some existing retro-fit arrangements often materially alter the engine mounting structure within the engine bay of the vehicle in order to mount the electric motor. Not only is such a material change in the mounting structure difficult and time consuming in relation to existing internal combustion engine driven vehicles, it also necessitates new testing for crash worthiness, in order to meet regulatory and consumer demands in relation vehicle safety.

The present invention has been developed with the above drawbacks in mind. Applicant has an expectation that the engine mounting arrangement of the invention can provide improvements in the ability of a vehicle which is retro-fitted with an electric motor drive to meet design regulations relating to front end collision. Applicant has a further expectation that the engine mounting arrangement of the invention can also facilitate retro-fitting at a reduced cost. Application further expects that the invention can be employed in new vehicles and not just in the retro-fitting of existing vehicles.

### SUMMARY OF THE INVENTION

According to the present invention there is provided an electric engine arrangement for mounting an electric motor in an engine bay of a vehicle which has engine mounts suitable for the mounting of an internal combustion engine, the arrangement including a mounting member, and an electric motor, the mounting member including opposite ends and a mounting section between the ends, the opposite ends of the mounting member being anchored to the engine mounts in the engine bay and the electric motor being mounted to the mounting section of the mounting member.

The mounting member can include an elongate strut that bridges between the engine mounts. In some arrangements, the strut extends between the engine mounts at about the same elevation of those mounts. By this arrangement, advantageously the components of the electric vehicle engine arrangement can be supported on the mounting member in positions which enable the arrangement to have a similar size or bulk as the internal combustion engine it replaces.

The mounting member can include at least two support arms which extend on either side of the elongate strut. The support arms can extend at any suitable angle relative to the strut. The arrangement is such that with the strut extending east-west between the engine mounts, one of the support arms extends in a direction towards the front of the vehicle, while the other extends in the opposite direction towards the rear of the vehicle. The support arms are employed in order to support the electric motor, or other components of the electric vehicle engine arrangement as may be provided.

While the mounting member can include only two support arms extending in the manner indicated above, some arrangements employ four support arms, two of which extend on one side of the strut and two of which extend on the other side. In this arrangement, the arms on each side of the strut are spaced apart lengthwise of the strut. By the provision of two support arms on either side of the strut, a stable supporting arrangement can be provided for supporting the electric motor, or other components that are provided with the arrangement. Alternatively, a single arm could be provided to extend from either side of the strut, with the arm having a broad width. Such an arm could provide a broad surface for the support of an electric motor or other components.

For vehicle safety purposes, applicant has developed arms which fold under a vehicle collision impact load. For this, the arms can be formed with a position of weakness, so that under a significant impact load which is experienced during a vehicle collision, the arms will fold at the point of weakness. Folding of the arms can limit the likelihood of the arms penetrating through the firewall of the engine bay and into the vehicle cabin, while the forward extending arms can fold so as to prevent them from piercing through the front end of the vehicle. Folding of the arms also assist movement of the engine arrangement under an impact load, to shift in a desirable manner to protect the vehicle occupants. The desired shifting movement is for the engine to “submarine”, or in other words, to shift downwardly as the impact occurs so that the engine arrangement moves underneath the vehicle, rather than moving directly rearwardly and engaging the firewall of the engine bay, which separates the engine bay from the vehicle cabin.

The arms can be formed of channel shaped metal and the point of weakness can be a notch which is provided in the walls of the channel.

While the invention in its broadest form includes a mounting member and an electric motor, in most arrangements the engine arrangement will further include a gearbox in connection with the electric motor and which is in connection with suitable drive arrangement for driving the wheels of the vehicle, usually the front wheels. For the present invention, is it intended that the engine arrangement be such that there is no requirement for modification of the drive arrangement, but rather, the engine arrangement is intended to be constructed so that it connects directly to the existing drive arrangement. By constructing the invention in this matter, cost savings can be realised by not requiring alteration to the existing drive arrangement, while the complexity of installation can be reduced.

The mounting section can include a support ring which is fixed to the mounting section and which facilitates mounting of the electric motor to the mounting member. In one form, the support ring extends below the mounting member and is disposed in a plane which is substantially perpendicular to a line extending between the engine mounts. The support ring can be employed to support the gearbox below the mounting member and to connect the gearbox to the electric motor.

The engine arrangement would further often include an electric motor controller/inverter and a battery station. The battery station is employed to store electrical energy and to feed that energy through the motor controller/inverter for distribution to the electric motor. Advantageously, the present invention can employ regenerative wheel braking in order to generate electrical power during vehicle braking for storage within the batteries of the arrangement.

In an engine arrangement including the components discussed above, the preference is for the electric motor, the gearbox and the battery station to be mounted below the elongate strut, and for the electric controller/inverter to be mounted above the strut. By this arrangement, the size and bulk of the arrangement can be configured to be similar to an internal combustion engine which the arrangement of the invention replaces, while the arrangement can also be such as to assist the submarining of the engine arrangement under a frontal collision impact.

While the battery station is employed for the storage of electrical energy, the battery station can also provide a critical component of the engine in respect of absorbing impact loads during a vehicle collision. This is because the battery station has a significant mass and because it can be located both forwardmost in the engine bay and extending across the engine bay approximately the distance between the engine mounts. By this arrangement, frontal impact loads tend to impact first on the battery station and because of the size and bulk of the station, the energy of the impact load can be absorbed evenly across the front end of the vehicle. Moreover, loading the battery station in this manner tends to cause the overall engine arrangement to advantageously submarine under the vehicle during a collision in the same manner as the original internal combustion engine would submarine under the same impact. The arrangement of the invention can therefore act in the same or similar manner as the internal combustion engine it replaces.

The design and position of the battery station according to the invention is unique and provides significant advantages as discussed above. Applicant is not aware of any equivalent arrangement existing in electrical engine arrangements elsewhere.

In some arrangements, further space is available for a second battery station to be mounted adjacent to the electric motor controller/inverter above the elongate strut.

It will be appreciated from the above discussion, that a critical component of the engine arrangement according to the invention is the mounting member. The mounting member is intended for connection or attachment to the existing engine mounts of an internal combustion for a retro-fit of the engine arrangement according to the invention, or to the existing engine mounts of production vehicles that could alternatively be fitted with an internal combustion engine. The retro-fit market is considered to be an important market for the present invention, because there are millions of internal combustion engine driven vehicles that could be retro-fitted with the engine arrangement of the invention. Such a retro-fit is expected to be considered desirable as oil prices rise and greenhouse emissions are required to be reduced. Moreover, it is not expected that vehicle manufacturers will be able to meet the rapidly increasing demand for all-electric vehicles in the near future. Accordingly, retro-fit of existing internal combustion engine driven vehicles is a mechanism by which more electric vehicles can be placed on road at an economical cost, while still maintaining the safety standards associated with vehicle prior to the retro-fit, ie when the vehicle was fitted with an internal combustion engine.

The present invention also provides a method of retro-fitting an electric motor to a vehicle which is driven by an internal combustion engine, the method including the steps of removing the internal combustion engine from engine mounts of the vehicle; providing an elongate mounting member having a fitting at each end and a mounting section between the fittings; fixing the mounting member to the vehicle by anchoring a first of the fittings to a first one of the engine mounts and a second of the fittings to a second one of the engine mounts such that the mounting member bridges across the engine bay of the vehicle; and mounting the electric motor to the mounting section of the mounting member.

The method steps of the invention can be undertaken in any suitable order. For example, the step of mounting the electric motor to the mounting member can take place before the mounting member is fixed to the engine mounts.

For a better understanding of the invention and to show how it may be performed, embodiments thereof will now be described, by way of non-limiting example only, with reference to the accompanying drawings.

### BRIEF DESCRIPTION OF THE DRAWINGS

FIG. 1 is a side view of an engine arrangement according to the invention.

FIG. 2 is a plan view of a mounting member according to the invention.

FIG. 3 is an end view of the mounting member of FIG. 2.

FIG. 4 is a side view of the mounting member of FIG. 2.

FIG. 5 is a further end view of the mounting member of FIG. 2.

FIG. 6 is a front view of the engine arrangement of FIG. 1.

FIGS. 7 and 8 are front and perspective views of a support ring for use in the present invention.

FIG. 9 is a side view of the engine arrangement of FIG. 1, showing torque absorption connections.

FIG. 10 shows a comparison between an internal combustion engine of the prior art and an engine arrangement according to the invention.

### DETAILED DESCRIPTION OF THE DRAWINGS

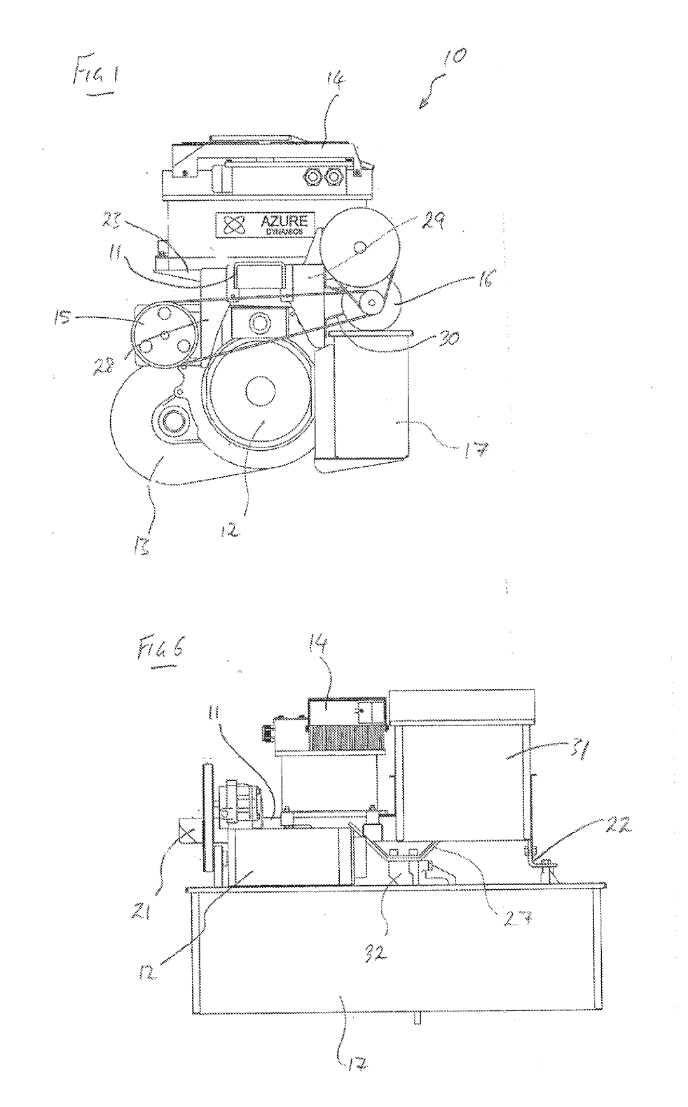

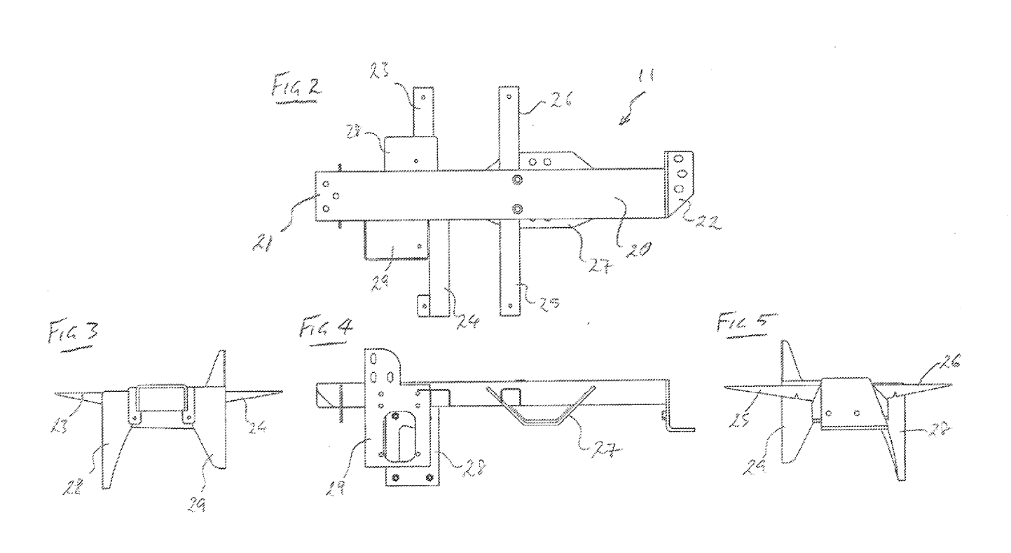

FIG. 1 is a side view of an engine arrangement 10 according to the invention. The arrangement 10 includes a mounting member 11, which is illustrated in more detail in relation to FIGS. 2 to 5, an electric drive motor 12, a gear box 13, a motor controller/inverter 14 to control the drive motor 12, a pump 15 which forms part of an air-conditioning unit, a brake vacuum pump and an auxiliary motor 16. The assembly 10 further includes a battery box 17, within which one or more suitable electric storage batteries can be housed. The preference is for lithium iron phosphate batteries, although other batteries can be employed selected on the basis of size, efficiency, power output etc. Various belt drives and electrical connections are employed in the arrangement, some of which are visible in the figures. The requirement for and style of these drives and connections will be readily appreciated by a person skilled in the art and will not be further described herein.

The components of the arrangement 10 can be selected as appropriate to suit the requirements of the arrangement. In particular the power output of the electric motor can be selected as appropriate for the size of vehicle to which the arrangement is to be fitted. The power output will form the basis of the selection of a suitable electric controller/inverter.

Referring to FIGS. 2 to 5, the mounting member 11 comprises an elongate strut 20, which when installed in the engine bay of a vehicle, runs laterally or east-west between the chassis rails of the vehicle, or if the vehicle employs a unitary body construction, the elongate strut 20 runs east-west between opposite rails of the subframe. A reference to rails hereinafter will encompass the chassis rails or subframe members.

The strut 20 extends across the engine bay at about the same elevation as the existing engine mounts. The strut 20 is a C-shaped channel which is of constant cross-section throughout its length. The strut 20 is a linear strut that extends directly from one engine mount to the other.

The strut 20 includes opposite ends 21, 22, which include openings for fixing each end to the existing engine mounts of a vehicle to which an internal combustion engine was fitted or intended to be fitted. The ends 21, 22 can be constructed for direct connection to the existing engine mounts or they can be connected to an adapter which facilitates connection to the existing engine mounts. What is intended is that the existing engine mounts form the mounts to which the elongate strut 11 can be mounted without modification of those mounts, or the need to create new mounts without using the existing engine mounts. In FIGS. 2, 4 and 5, the end 22 of the strut 20 is shown as a part which is welded to the strut 20 and which extends downwardly for connection to an existing engine mount. The end 21 is an integral part of the strut 20.

The ends 21, 22 are at the opposite distal ends of the strut 20. Between the ends 21, 22 is a mounting section for mounting the electric drive motor 12, the gearbox 13 and the other components referred to in FIG. 1 earlier. The strut 20 thus includes laterally extending arms 23 to 26, a saddle 27 and legs 28, 29, each connected to the strut 20. The arms 23 to 26 extend perpendicular to the lengthwise extent of the strut 20 and each extends to approximately the same extent from the strut 20. The arms 20 are C-shaped channel sections, but the walls of the channel reduce in depth as the channels extend from the strut 20.

The legs 28 and 29 extend downwardly, perpendicular to the strut 20 and the arms 23 to 26. As shown in FIG. 4, the legs are formed for attachment of engine components via suitable openings. For example, FIG. 1 shows a bracket 30 for attachment of the auxiliary motor 16. The legs are C-shaped channel sections.

The position and configuration of the components of the mounting section can be altered as required to suit different components, such as different capacity electric motors, different size gearbox, the inclusion of air conditioning apparatus, the inclusion of power steering apparatus, etc. The components can be fixed to the strut 20 in any suitable manner such as by welding or bolting, or by suitable brackets or other fittings.

The arms 23 to 26 support the controller/inverter. The saddle 27 supports the support ring for supporting the drive motor 12 and the gearbox 13. The legs 28, 29 support the air conditioning compressor, power steering pump and auxiliary motor.

The shape and position of the components of the mounting member 11 is such as to provide for slight spacing between the engine components when they are fitted to the mounting member. This provides a safety benefit in that under a frontal impact situation, the engine components can shift slightly relative to each other in order to absorb impact. To increase this absorption effect, each of the components of the mounting member 11 can be arranged to bend or distort under impact loading, so that the shifting movement between the engine components can occur. This arrangement thus acts like a sponge under an impact load, absorbing the load. Such a mechanism does not occur in an internal combustion engine.

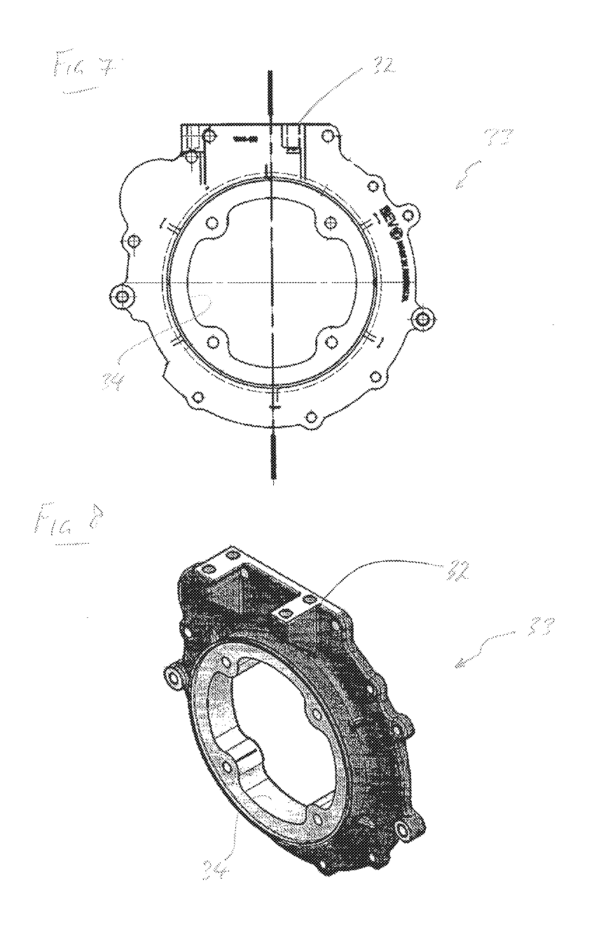

FIG. 6 is end view of the arrangement 10, rotated 90° from FIG. 1, which shows an additional battery box 31 located on the upper side of the strut 20 adjacent the motor controller/inverter 14. The battery box 31 provides additional energy storage to the other battery box 17.

FIG. 6 also illustrates the upper end 32 of a support ring which is bolted to the saddle 27. FIGS. 7 and 8 illustrate the support ring in detail, and show the support ring 33 as having an opening 34 through which the drive shaft (not shown) of the drive motor 12 extends into the gearbox. The support ring 33 is intended to support the gearbox 13 beneath the strut 20, with the support ring 33 being suspended below the strut 20 via connection of the upper end 32 bolted to the saddle 27. The support ring 33 also connects to the drive motor 12, to support the drive motor 12 relative to the gearbox 13. It can be seen from FIGS. 7 and 8 that the support ring 33 includes various threaded openings for connection between the drive motor 12 and the gearbox 13.

It is intended that the arrangement 10 will employ further mounts as already used in internal combustion engine arrangements, such as a gearbox mount to the subframe. That mount is intended principally for torque absorption under vehicle acceleration. Further torque absorption can be provided by utilising the exhaust pipe mounts employed for an internal combustion engine. For this, a strut which can include a shock absorber can extend from the electric engine to the rubber exhaust pipe mounts.

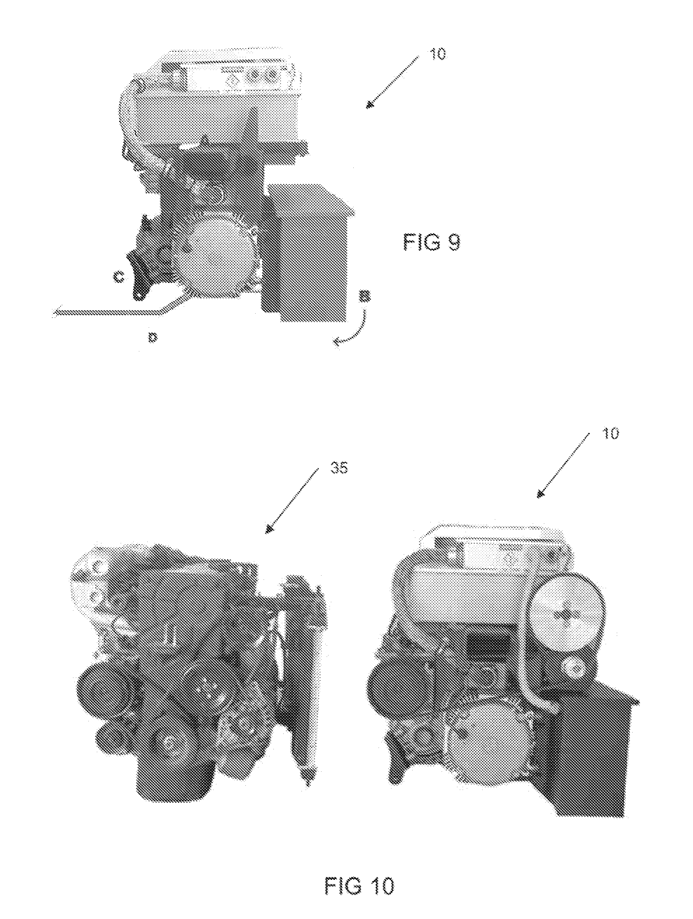

FIG. 9 illustrates the further mounts which are intended for use with the arrangement 10. The mount indicated at C is a mounting point intended to control engine torque, while the mount indicated at D is a rod that is intended to act like the exhaust pipe of the original internal combustion engine. Thus, the rod is mounted to the original exhaust pipe mounts under the vehicle, and to the engine arrangement 10 at or adjacent the drive motor 12, and that mount also acts to soften the torque generated by the electric motor. The arrows illustrated at A and B, are intended to illustrate the direction in which the arrangement 10 submarines under a frontal impact, which engages the arrangement 10 at the battery box 17.

A unique aspect of the design of the strut 20 and the particular manner in which the components are mounted to it, is in the ability of the strut to facilitate impact absorption during a frontal collision. For example, each of the arms 23 to 26 can be notched in the underside web thereof as viewed in FIG. 3 for example, so that the arms fold during a frontal collision. It is to be noted that the arms 23 to 26 extend in the direction of travel of a vehicle given that the strut 20 extends across the engine bay in an east-west configuration. Thus collapsing of the arms 23 to 26 advantageously shifts them in a collision from the extended position shown in the figures and for example, prevents the rearward extending arms from penetrating into the vehicle cabin through the firewall of the vehicle.

Moreover and with reference to FIG. 1, the battery box 17 is mounted at the furthest point forward of the arrangement 10. As is evident from FIG. 6, the battery box 17 is mounted low and extending laterally across the arrangement 10. This position is behind the vehicle radiator or the air conditioning condenser in the case of an air cooled electric drive motor, where the exhaust extractors of the internal combustion engine would have been located. The position of the battery box is very important. It has the dual role of absorbing frontal impact loads that the exhaust extractors would otherwise have at least partially absorbed, while it also causes the entire arrangement 10 to shift in a desired manner under high impact loading. That desired shift is to submarine under the vehicle rather than to shift rearwardly through the firewall of the vehicle and into the vehicle cabin. The battery box 17 thus has two functions namely that of energy storage and impact absorption.

The design of the arrangement 10 is also intended to permit collapse of the arrangement without bottoming out. Bottoming out is when the front end of a vehicle has collapsed to the maximum extent and no further energy absorption is available. The present invention attempts to delay bottoming out by the slight spacing apart of the engine components so that they can shift relative to each other under impact loading, and by the use of the battery box 17 in the front position and extending across the engine bay. The delay or elimination of bottoming out is recognised as a significant factor in the prevention of injury to vehicle occupants in frontal collisions.

The arrangement 10 thus is intended to react in a way under a frontal collision that is similar to the way an internal combustion engine would react. This is an advantage particularly for retro-fit applications, because there can be a confidence after retro-fit that the safety of the vehicle has not been compromised by removal of the internal combustion engine.

To illustrate this point more fully, FIG. 10 provides a photographic comparison between the engine arrangement 35 of an internal combustion engine as compared to the arrangement 10 according to the invention. It can be seen that the arrangement 10 is of similar bulk to the internal combustion engine arrangement 35. Additionally, the weight and mass of the two arrangements 10, 35 are similar so that the impact absorption characteristics of the two arrangements 10, 35 do not differ significantly. This has resulted in a major cost saving in Australia, given that the relevant regulatory body, the Australian Road Safety Authority, has accepted use of the invention for small production runs without requiring further and expensive crash testing to be undertaken.

In relation to safety, the applicant has an expectation that the arrangement 10 will exhibit energy absorption in a frontal collision more evenly than an internal combustion engine would, on the basis that the mounting member 11 supports the various components allowing for some movement relative to each other in frontal collision, whereas the solid engine block of an internal combustion engine does not have give of this kind. In other words, the arrangement 10 acts in a sponge like manner when absorbing impact loads, thus cushioning the impact load in a manner not provided by an internal combustion engine.

The arrangement 10 has been successfully tested within a vehicle that previously was driven through an east-west mounted internal combustion engine. The vehicle was a relatively small four cylinder passenger vehicle, produced by the Korean car maker Hyundai, under the brand name Getz. The arrangement 10 was able to provide acceleration from 0 to 60 kmh in 7 seconds, with a 120 km range and 110 kmh top speed, achieved through the use of 40 kw electric motor. Thus, the vehicle performed in a very satisfactory manner.

The componentry employed in the arrangement 10 was as follows:

Electric motor—Azure Dynamics AC24
Electric controller/inverter—Azure Dynamics DMOC445
Gearbox—Standard manual Hyundai Getz gear box
Hyundai Air conditioning compressor
Hyundai hydraulic power steering pump
Self designed coupling ring
Self designed battery boxes
Self designed support strut
Self designed auxiliary motor

The invention described herein is susceptible to variations, modifications and/or additions other than those specifically described and it is to be understood that the invention includes all such variations, modifications and/or additions which fall within the spirit and scope of the above description.

1. An electric vehicle engine arrangement for a vehicle which has engine mounts suitable for the mounting of an internal combustion engine, the arrangement including a mounting member for mounting an electric motor in the engine bay of the vehicle, the mounting member including opposite ends and a mounting section between the ends, the opposite ends of the mounting member being anchored to the engine mounts in the engine bay and the electric motor being mounted to the mounting section of the mounting member.

2. An electric vehicle engine arrangement according to claim 1, the mounting member including an elongate strut that bridges between the engine mounts, at about the same elevation as the engine mounts.

3. An electric vehicle engine arrangement according to claim 2, the mounting member including at least two support arms which extend on either side of the strut.

4. An electric vehicle engine arrangement according to claim 3, the mounting member including four support arms two of which extend on one side of the strut and two of which extend on the other side of the strut, the arms on each side of the strut being spaced apart lengthwise of the strut.

5. An electric vehicle engine arrangement according to claim 2, one or more of the arms being foldable under a vehicle collision impact load.

6. An electric vehicle engine arrangement according to claim 5, the one or more arms being channel shaped and including a weakness point in the walls of the channel to facilitate folding under a vehicle collision impact load.

7. An electric vehicle arrangement according to claim 2, the arrangement further including a gearbox in connection with the electric motor, the gearbox and electric motor being suspended below the elongate strut by a support ring, which is connected to the strut.

8. An electric vehicle arrangement according to claim 7, wherein the support ring is positioned between the electric motor and the gearbox and the shaft extends through the ring to connect the electric motor to drive the gearbox.

9. An electric vehicle engine arrangement according to claim 2, the arrangement further including a gearbox in connection with the electric motor, an electric motor controller/inverter and a battery station, the electric motor, gearbox and the battery station being mounted below the elongate strut and the electric motor controller/inverter being mounted above the elongate strut.

10. An electric vehicle engine arrangement according to claim 9, the battery station being located forwardmost in the engine bay and extending across the engine bay.

11. An electric vehicle engine arrangement according to claim 9, the battery station being located for initial impact in a frontal collision.

12. An electric vehicle engine arrangement according to claim 9, the arrangement including a further battery station mounted adjacent the electric motor controller/inverter above the elongate strut.

13. An electric vehicle engine arrangement according to claim 1, the arrangement being similar in size, weight and mass to an internal combustion engine that could be fitted to the engine mounts of the vehicle to which the mounting member is fitted.

14. A mounting member for use in an electric vehicle engine arrangement according to claim 1.

15. A method of retro-fitting an electric motor to a vehicle which is driven by an internal combustion engine, a method including the steps of removing the internal combustion engine from engine mounts of the vehicle; providing an elongate mounting member having a fitting at each end and a mounting section between the fittings; fixing the mounting member to the vehicle by anchoring a first of the fittings to a first one of the engine mounts and a second of the fittings to a second one of the engine mounts such that the mounting member bridges across the engine bay of the vehicle; and mounting the electric motor to the mounting section of the mounting member.

16. A method according to claim 15, the step of mounting the electric motor to the mounting member takes place before the mounting member is fixed to the engine mounts.

17. A vehicle to which an electric vehicle engine arrangement according to claim 1.
